(19) United States
(12) Patent Application Publication
(10) Pub. No.: US 2017/0204203 A1
(43) Pub. Date: Jul. 20, 2017

(54) POLY ALPHA-1,3-GLUCAN SOLUTION COMPOSITIONS

(71) Applicant: E. I. DU PONT DE NEMOURS AND COMPANY, Wilmington, DE (US)

(72) Inventors: Debra Flanagan MASSOUDA, Wilmington, DE (US); Vindhya MISHRA, Wilmington, DE (US)

(21) Appl. No.: 15/320,872

(22) PCT Filed: Jun. 25, 2015
(86) PCT No.: PCT/US2015/037624

§ 371 Date: Dec. 21, 2016

Related U.S. Application Data
(60) Provisional application No. 62/017,333, filed on Jun. 26, 2014.

(51) Int. Cl. C08B 37/00; C08J 5/18

(52) U.S. Cl. CPC C08B 37/0009; C08J 5/18; C08J 2305/00

(57) ABSTRACT

Solution compositions of poly alpha 1,3 glucan useful for making films and other formed objects are disclosed.

### CROSS-REFERENCE TO RELATED APPLICATION

This disclosure claims the benefit of priority of U.S. Provisional Application No. 62/017333, filed on Jun. 26, 2014, the entirety of which is herein incorporated by reference.

### FIELD OF THE INVENTION

This disclosure relates to poly alpha-1,3-glucan solution compositions useful for making films and other formed objects.

### BACKGROUND

Glucose-based polysaccharides and their derivatives can be of potential industrial application.

Cellulose is a typical example of such a polysaccharide and is comprised of beta-1,4-D-glycosidic linkages of hexopyranose units. Cellulose is used for several commercial applications such as in manufacture of fibers, films (cellophane), sponges and food casings. Cellulose for industrial applications is derived from wood pulp. Solutioning of cellulose is a difficult procedure. For production of objects from regenerated cellulose, the most commonly used process for dissolution of cellulose is the ‘viscose process’ where the cellulose is converted to cellulose xanthate made by treating a cellulose compound with sodium hydroxide and carbon disulfide. The use of this process involves toxic chemicals and significant environmental costs.

Amongst polysaccharide polymers, glucan polymers, with alpha-1,3-glycoside linkages, have been shown to possess significant advantages. U.S. Pat. No. 7,000,000 disclosed preparation of a polysaccharide fiber comprising a polymer with hexose units, wherein at least 50% of the hexose units within the polymer were linked via alpha-1,3-glycoside linkages, and a number average degree of polymerization of at least 100. A glucosyltransferase enzyme from Streptococcus salivarius (gtfJ) was used to produce the polymer. The polymer formed a solution when it was dissolved in a solvent or in a mixture comprising a solvent. From this solution continuous, strong, cotton-like fibers, highly suitable for use in textiles, were spun and used.

It would be desirable to make polysaccharide formed objects, such as films, similar to those now made from cellulose but without the use of the toxic chemicals that are now used to dissolve cellulose.

### SUMMARY

In a first embodiment, the disclosure concerns a solution comprising poly alpha-1,3-glucan and aqueous potassium hydroxide wherein the solids concentration of poly alpha-1,3-glucan is in the range of greater than 20% to 28% based on the total weight of the solution; and wherein the concentration of aqueous potassium hydroxide is in the range of 7% to 25%.

In a second embodiment, the disclosure concerns a solution comprising poly alpha-1,3-glucan and aqueous potassium hydroxide wherein the solids concentration of poly alpha-1,3-glucan is in the range of 10% to 20% based on the total weight of the solution; and wherein the concentration of aqueous potassium hydroxide is in the range of greater than 10% to 25%.

### DETAILED DESCRIPTION

The disclosures of all cited patent and non-patent literature are incorporated herein by reference in their entirety.

As used herein, the term “invention” or “disclosed invention” is not meant to be limiting, but applies generally to any of the inventions defined in the claims or described herein. These terms are used interchangeably herein. Unless otherwise disclosed, the terms “a” and “an” as used herein are intended to encompass one or more (i.e., at least one) of a referenced feature.

The terms “poly alpha-1,3-glucan”, “alpha-1,3-glucan polymer”, “glucan polymer” and “glucan” are used interchangeably herein. Poly alpha-1,3-glucan is a polymer where the structure of poly alpha-1,3-glucan can be illustrated as follows (where n is 8 or more):

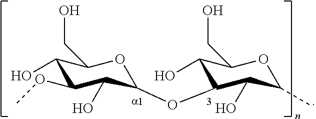

Poly alpha-1,3-glucan, useful for certain embodiments of the disclosure, can be prepared using chemical methods. Alternatively, it can be prepared by extracting it from various organisms, such as fungi, that produce poly alpha-1,3-glucan. Poly alpha-1,3-glucan useful for certain embodiments of the disclosure can also be enzymatically produced from renewable resources, such as sucrose, using one or more glucosyl-transferase (e.g., gtfJ) enzyme catalysts found in microorganisms as described in the co-pending, commonly owned U.S. Patent Application Publication No. 2013/0244288 which is herein incorporated by reference in its entirety.

Solutions of poly alpha-1,3-glucan in aqueous potassium hydroxide were prepared by mixing poly alpha-1,3-glucan is mixed into the solvent composition by application of shear.

The present disclosure is directed toward a solution comprising poly alpha-1,3-glucan and aqueous potassium hydroxide wherein the solids concentration of poly alpha-1,3-glucan is in the range of greater than 20% to 28%, preferably 22% to 28% and more preferably 22% to 25% based on the total weight of the solution; and wherein the concentration of aqueous potassium hydroxide is in the range of 7% to 25%, preferably 10% to 25% and more preferably 15% of 25%.

In another embodiment, the present disclosure is directed toward a solution comprising poly alpha-1,3-glucan and aqueous potassium hydroxide wherein the solids concentration of poly alpha-1,3-glucan is in the range of 10% to 20%, preferably 12% to 20% and more preferably 15 to 20% based on the total weight of the solution; and wherein the concentration of aqueous potassium hydroxide is in the range of greater than 10% to 25% and preferably 15% to 25%.

The poly alpha-1,3-glucan can have a DPw from at least about 400, but DPw's of 550 and above are preferred. It was found that the lower

DPw polymers go into solution, but for certain solution compositions, over various time periods from 1 hour to several days, they appear to crystallize and form an opaque, waxy solid. Polymers with higher DPw's maintain a transparent solution for periods of time longer than several weeks.

### EXAMPLES

The present disclosure is further exemplified in the following Examples. It should be understood that these Examples, while indicating certain preferred aspects herein, are given by way of illustration only. From the above discussion and these Examples, one skilled in the art can ascertain the essential characteristics of the disclosed embodiments, and without departing from the spirit and scope thereof, can make various changes and modifications to adapt the disclosed embodiments to various uses and conditions.

### Abbreviations

“DI water” is deionized water; “KOH” is potassium hydroxide; “DPw” is weight average degree of polymerization.

### General Methods

In the non-limiting examples that follow, the following test methods were employed to determine various reported characteristics and properties.

### Degree of Polymerization

(DPw) was determined by size exclusion chromatography (SEC). The molecular weight of a poly alpha-1,3-glucan can be measured as number-average molecular weight (Mₙ) or as weight-average molecular weight (M_{w}). The degree of polymerization can then be expressed as DP_{w} (weight average degree of polymerization) which is obtained by diving M_{w} of the polymer by the weight of the monomer unit, or DPₙ (number average degree of polymerization) which is obtained by dividing Mₙ of the polymer by the weight of the monomer unit. The chromatographic system used was Alliance™ 2695 liquid chromatograph from Waters Corporation (Milford, Mass.) coupled with three on-line detectors: differential refractometer 410 from Waters, multiangle light scattering photometer Heleos™ 8+from Wyatt Technologies (Santa Barbara, Calif.) and differential capillary viscometer ViscoStar™ from Wyatt. The software packages used for data reduction were Empower™ version 3 from Waters (column calibration with broad glucan standard, DR detector only) and Astra version 6 from Wyatt (triple detection method without column calibration). Four SEC styrene-divinyl benzene columns from Shodex (Japan) were used—two linear KD-806M, KD-802 and KD-801 to improve resolution at low molecular weight region of a polymer distribution. The mobile phase was N, N′—Dimethyl Acetamide (DMAc) from J. T Baker, Phillipsburg, N.J. with 0.11% LiCl (Aldrich, Milwaukee, Wis.). The chromatographic conditions were as follows: Temperature at column and detector compartments: 50 C, temperature at sample and injector compartments: 40 C, flow rate: 0.5 ml/min, injection volume: 100 ul. The sample preparation targeted 0.5 mg/mL sample concentration in DMAc with 5% LiCl, shaking overnight at 100 C. After dissolution, polymer solution can be stored at room temperature.

### Solution Quality

Whether or not a solution is created is determined visually. When a blend of glucan powder and aqueous potassium hydroxide becomes transparent, it is said to be dissolved. These solutions are generally amber-colored, but transparent.

### Preparation of Poly alpha-1,3-glucan

Poly alpha-1,3-glucan, using a gtfJ enzyme preparation, was prepared as described in the co-pending, commonly owned U.S. Patent Application Publication Number 2013-0244288 which was published on Sep. 19, 2013, the disclosure of which is incorporated herein by reference.

### Example 1

### Poly Alpha-1,3-Glucan Solution

Poly alpha-1,3-glucan polymer powder was dried in a vacuum oven at 60 ° C. overnight. Ten g poly alpha-1,3-glucan solid of DPw 650 was slurried in 25 g of water. 160 g of KOH (available from EMD Chemicals, Billerica, Mass.) was dissolved in 240 g of water to make a 40% KOH solution. Fifteen g of the 40% KOH solution was then added to the alpha-1,3-glucan slurry and mixed by hand until the polymer was completely dispersed. It became dissolved by the next day at room temperature even without continuous stirring to make a solution of poly alpha-1,3-glucan.

The final solution concentration was 20 wt % poly alpha-1,3-glucan and 12.0 wt % KOH. The solvent composition defined as the weight of KOH divided by the weight of KOH and water was 15%. The solution concentrations are summarized in the Table. It should be noted that the alpha-1,3-glucan powder could be added directly to a 15% KOH solution in water if high shear equipment is used. However, by first making a water slurry of alpha-1,3-glucan before introducing the KOH solution, helped to prevent clumping of the alpha-1,3-glucan. KOH solutions of 20% to 40% are typically mixed with the glucan powder slurried in water. These solutions are hand mixed or stirred with a laboratory mixer, depending on the quantity required.

Thus, a poly alpha-1,3-glucan solution was created by dissolving poly alpha-1,3-glucan in aqueous KOH.

### Examples 2-6

### Poly Alpha-1,3-Glucan Solutions Prepared from a Range of Poly Alpha-1,3-Glucan DPw Values

Examples 2 through 6 were prepared in a similar manner to Example 1 using alpha-1,3-glucan with different DPw values. The Examples were soluble and are summarized in the Table. The higher concentrations of the lower DPw polymer became soluble at least temporarily before the solution crystallized.

Thus, various poly alpha-1,3-glucan solutions were created by dissolving poly alpha-1,3-glucan with different DPw values in aqueous KOH.

TABLE
Glucan Solution Concentrations

| | | | KOH % | KOH % |
|---|---|---|---|---|
| | Glucan | Glucan wt % | (based on solvent | (based on total |
| Example | DPw | (based on total) | (KOH + water)) | solution) |
| 1 | 650 | 20.0 | 15.0 | 12.0 |
| 2 | 800 | 22.0 | 15.0 | 11.7 |
| 3 | 800 | 18.0 | 15.0 | 12.3 |
| 4 | 550 | 23.0 | 15.0 | 11.6 |
| 5 | 550 | 20.0 | 25.0 | 20.0 |
| 6 | 440 | 25.0 | 15.0 | 11.7 |

What is claimed is:

1. A solution comprising poly alpha-1,3-glucan and aqueous potassium hydroxide wherein the solids concentration of poly alpha-1,3-glucan is in the range of greater than 20% to 28% based on the total weight of the solution; and wherein the concentration of aqueous potassium hydroxide is in the range of 7% to 25%.

2. A solution comprising poly alpha-1,3-glucan and aqueous potassium hydroxide wherein the solids concentration of poly alpha-1,3-glucan is in the range of 10% to 20% based on the total weight of the solution; and wherein the concentration of aqueous potassium hydroxide is in the range of greater than 10% to 25%.
